(19) United States
(12) Patent Application Publication
(10) Pub. No.: US 2006/0026456 A1
(43) Pub. Date: Feb. 2, 2006

(54) Data storage apparatus and data storage method thereof

(76) Inventors: Yoshiaki Kayukawa, Kanagawa (JP); Toshiya Asai, Kanagawa (JP)

Correspondence Address: WILLIAM S. FROMMER, Esq.;c/o FROMMER LAWRENCE & HAUG LLP, 745 Fifth Avenue, New York, NY, 10151, US

(21) Appl. No.: 11/189,424

(22) Filed: Jul. 26, 2005

(30) Foreign Application Priority Data
Jul. 28, 2004 (JP) P2004-220497

(51) Int. Cl. G06F 11/00

(52) U.S. Cl. 714/5

(57) ABSTRACT

A data storage apparatus and data storage method thereof which enable reduction of the number of maintenance sessions to replace malfunctioning storage means are provided. The data storage apparatus has a plurality of data HDDs; a plurality of error correction HDDs; a data distribution and error code generation device, which distributes and records input data in the data HDDs, and which generates error correction codes from the data according to the number of error correction HDDs and records the error correction codes in the error correction HDDs; and a data restoration device, which restores the data within HDDs in which a malfunction or response delay has occurred, using data and error correction codes read from the remaining HDDs.

### CROSS-REFERENCES TO RELATED APPLICATIONS

The present invention contains subject matter related to Japanese Patent Application JP 2004-220497, filed in the Japanese Patent Office on Jul. 28, 2004, the entire contents of which being incorporated herein by reference.

### BACKGROUND OF THE INVENTION

1. Field of the Invention

This invention relates to a data storage apparatus and data storage method thereof, suitable for application to an HDD array unit, for example.

2. Description of the Related Art

In recent years, HDD (Hard Disk Drive) array units have been coming into frequent use for storage of AV (Audio/Video) data at broadcast stations and in post-production. In an HDD array unit, a plurality of HDDs are installed in a single unit, to achieve both mass storage and high data transfer rates.

For example, a large storage capacity, high reliability, and high data transfer rates are also required of an AV server used as a nonlinear editing system in a broadcast station, and so HDD array units are used as storage. This AV server has a plurality of recording/reproduction ports, each of which inputs and outputs data streams at a high bit rate during operation. Demands imposed on the AV server include (1) absolute reliability in preventing failure of a video or audio stream during, for example, on-air transmission, and (2) response performance satisfying a certain minimum level (realtime properties).

However, the HDDs used as storage are devices with low reliability even compared with other devices in the system. Hence HDD array units are provided with redundancy in a RAID (Redundant Arrays of Inexpensive Disks) configuration, supporting functions to cope with various faults. Examples of such functions include parity-based error correction, data reconstruction through rebuilding, data reassignment processing (in which, when response delays occur for one HDD, the data of the HDD is corrected and output from another HDD), and shortened MTTR (Mean Time To Repair) through the mounting of spare HDDs.

In the past, HDD array units used in such AV servers and similar were configured as RAID level 3 or level 5 systems, and the HDD redundancy was only 1 (see Patent Reference 1, for example).
Patent Reference 1: Published Japanese Patent Application No. 2000-299835 (paragraphs 0058 and 0059, FIG. 2)

However, if one HDD malfunctions in such an HDD array unit with a redundancy of only 1, the remaining HDDs must be used to perform rebuilding and restore the data of the malfunctioning HDD, but until the rebuilding is completed the system must continue operation in a state with no redundancy (RAID level 0), and if during this time an error or a response delay occurs in another HDD, noise occurs in the video or audio stream, and in the worst case an on-air problem occurs.

In order that the state of no redundancy is as short as possible, the HDD must be replaced and rebuilding is completed as quickly as possible. To this end, an arrangement is employed in which the above-described spare HDD is mounted in advance, and rebuilding is started automatically immediately after the HDD malfunction. Even so, as the capacities of HDDs have grown in recent years, it has in some cases taken several days for rebuilding during system operation. In an AV server using such disk array equipment, it is essential that system reliability be maintained during maintenance to repair HDDs and during recovery.

In maintenance, two costs are incurred, which are the cost of replacement HDD preparation and the cost of on-site service by a service technician. Due to the steadily decreasing prices of HDDs, much of the cost of maintenance consists of the cost of on-site service by the technician. This maintenance cost is a substantial burden for users, and a major goal of disk alignment equipment is to reduce on-site service costs through fewer maintenance sessions. Moreover, the occurrence of the need for HDD recovery itself implies degraded reliability of a system operating at RAID level 0, and so there is a strong need to maintain system reliability during recovery.

In light of the above problems, this invention provides a data storage apparatus including a plurality of data storage means mounted in a single unit such as an HDD array unit, in which the ability to continue operation in a state in which redundancy is retained even when a malfunction or response delay occurs in one storage means, and the number of maintenance sessions to replace malfunctioning storage means is reduced.

### SUMMARY OF THE INVENTION

In order to obtain the above, a data storage apparatus according to an embodiment of this invention includes: a plurality of data recording means; a plurality of error correction recording means; data distribution and error correction code generation means for distributing and recording input data in data recording means, and for generating error correction codes from the data in accordance with the number of error correction recording means to record the error correction codes in error correction recording means; and data restoration means for restoring data within recording means in which a malfunction or response delay has occurred, among the data recording means and error correction recording means, using data and error correction codes read from the remaining recording means.

In this data storage apparatus, input data is distributed to a plurality of data recording means to be recorded, and error correction codes generated from the data in accordance with the number of error correction recording means are recorded in a plurality of error correction recording means. Hence the redundancy is equivalent to the number of error correction recording means.

When a malfunction or response delay occurs in any of the recording means, the data within the recording means is restored using data and error correction codes read from the remaining data recording means and error correction recording means. As explained above, because the redundancy is equivalent to the number of error correction recording means, even if a malfunction or response delay occurs in a number of recording means which is one less than the number of error correction recording means, a redundancy of 1 or greater can be maintained during data restoration.

By this means, even if a malfunction or response delay occurs in one recording means, operation can be continued in a state in which redundancy is secured.

Further, until malfunctions occur in the same number of recording means as the maximum number of error correction recording means, data can be restored even without replacing the malfunctioning recording means. Hence the number of maintenance sessions to replace malfunctioning recording means can be reduced.

Preferably, an example of this data storage apparatus further includes request output means for outputting information requesting replacement of malfunctioning recording means, and operation means for selecting whether or not to replace malfunctioning recording means, until recording means malfunction in the same quantity as the maximum number of error correction recording means, in which in the case where replacement is not selected by the operation means, this request output means halt output of the information even when malfunctioning recording means are not replaced.

As a result, the user can arbitrarily select whether or not to perform maintenance to replace any number of malfunctioning recording means, within the range in which the number is the same as the maximum number of error correction recording means.

Further, preferably, an example of this data storage apparatus further includes at least one spare recording means, request output means for outputting information to request replacement of malfunctioning recording means, and operation means for selecting whether or not to replace malfunctioning recording means, until recording means malfunction in at least the same quantity as the number of spare recording means, in which in the case where recording means are malfunctioning within the range of the number of spare recording means, the data restoration means record the restored data in the spare recording means, and in the case where the operation means selects replacement not to be performed, the request output means halt output of the information even when malfunctioning recording means are not replaced.

As a result, the user can arbitrarily select whether or not to perform maintenance to replace any number of malfunctioning recording means, up to the same number of malfunctioning recording means as the number of spare recording means, while maintaining redundancy equivalent to the number of error correction recording means. Further, when recording means are malfunctioning and spare recording means are still available, but there happens to be maintenance in progress (a service technician is on site), replacement can be selected, so that the total number of maintenance sessions can be further reduced.

In order to solve the above-described problems, a data storage method is proposed, similarly to the above-described data storage apparatus. The data storage method according to an embodiment of the present invention includes: a data distribution and recording step of distributing and recording input data to data recording means, an error correction code generation and recording step of generating error correction codes from the data in accordance with the number of error correction recording means and of recording the codes in the error correction recording means, and a data restoration step of restoring the data within recording means in which a malfunction or response delay has occurred among the data recording means and the error correction recording means, using the data and error correction codes read from the remaining correction means.

Further, as an example, a data storage method for a data storage apparatus including a plurality of data recording devices, a plurality of error correction recording devices, and at least one spare recording device, is proposed. This method includes: a data restoration step of restoring data within recording devices in which malfunctions or response delays have occurred among the data recording devices and error correction recording devices, using data and error correction codes read from the remaining recording devices, a request output step of outputting information to request replacement of malfunctioning recording devices, and an operation step of selecting whether or not to replace malfunctioning recording devices, until recording devices malfunction in at least the same quantity as the number of spare recording devices, wherein in the case where recording devices are malfunctioning in a number within the range of the number of spare recording devices, in the data restoration step the restored data is recorded to the spare recording devices, and in the case where replacement is not selected in the operation step, in the request output step the information output is halted even if malfunctioning recording devices are not replaced.

Similar operations to the above data storage apparatus can be obtained by the above methods.

According to the embodiments of this invention, there are the advantageous results that, in a data storage apparatus in which a plurality of data recording means are mounted in a single unit, operation can be continued in a state in which redundancy is secured even when a malfunction or response delay occurs in one recording means, and the number of maintenance sessions to replace malfunctioning recording means can be reduced.

There is also the advantageous result that the user can arbitrarily select whether or not to perform maintenance to replace any number of malfunctioning recording means, within the range of the maximum number of error correction recording means.

Furthermore, there is the advantageous result that the user can arbitrarily select whether or not to perform maintenance for replacement up to any number of malfunctioning recording means, while maintaining redundancy equivalent to the number of error correction recording means, up to a number of malfunctioning recording means equal to the number of spare recording means, as well as the advantageous result that when recording means are malfunctioning and spare recording means are still available, but there happens to be maintenance in progress, by selecting replacement, the total number of maintenance sessions can be further reduced.

### BRIEF DESCRIPTION OF THE DRAWINGS

FIG. 1 is a block diagram schematically showing the configuration of an AV server to which this invention is applied;

FIG. 2 is a block diagram showing the configuration of an HDD array unit in the storage unit of FIG. 1;

FIG. 3 is a block diagram showing the circuit configuration of the control board of FIG. 2;

FIG. 4 shows an external view of the control panel of FIG. 2; and,

FIG. 5 is a flow chart showing processing executed by the CPU of FIG. 3 at the time of an HDD malfunction.

### DESCRIPTION OF THE PREFERRED EMBODIMENTS

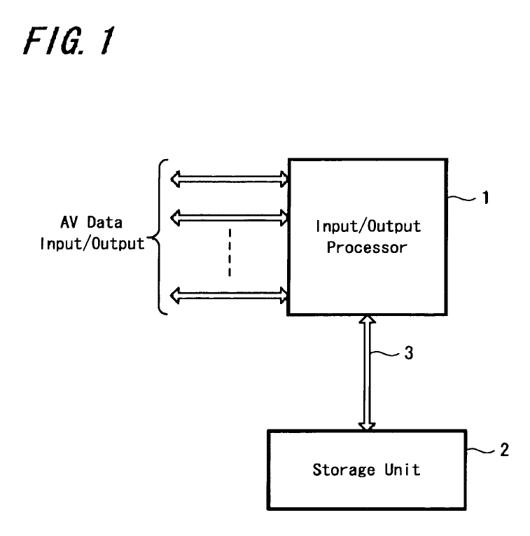

Hereinafter, embodiments in which the present invention is applied to an AV server used as a nonlinear editing system in a broadcast station are explained in detail using the drawings. FIG. 1 is a block diagram schematically showing the configuration of an AV server to which the invention is applied. The AV server includes an input/output processor 1 and a storage unit.

The input/output processor 1 has a plurality of (for example, six) input/output ports, and inputs and outputs AV data with external equipment in the SDI (Serial Digital Interface) or another synchronous transfer format, or in an asynchronous transfer format.

The input/output processor 1 encodes (compresses) AV data input from input/output ports in a predetermined encoding method, and transfers the data to the storage unit over fiber channel 3. The input/output processor 1 also decodes (expands) data transferred from the storage unit over fiber channel 3, and outputs the data from input/output ports.

Note that the configuration of the input/output processors in typical AV servers is well-known, and the configuration of the input/output processor of the AV server to which this invention is applied may have this typical configuration, and so a detailed explanation is omitted.

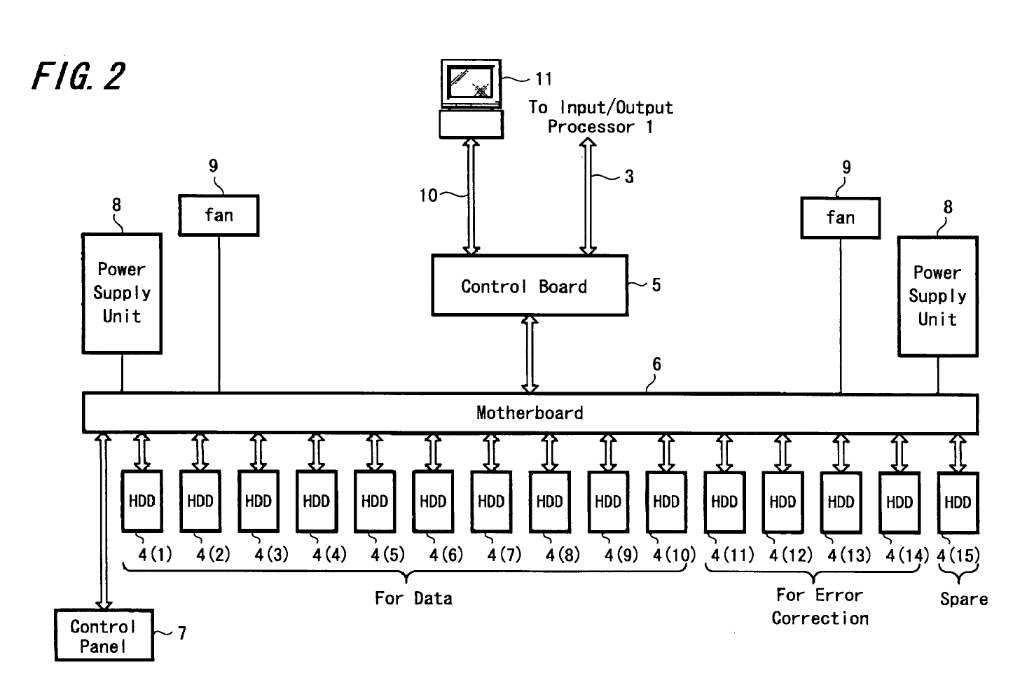

The storage unit has a plurality of HDD array units. FIG. 2 is a block diagram showing the configuration of one HDD array unit in the storage unit. This HDD array unit includes fifteen HDDs 4(1) to 4(15), a control board 5 to control each of the HDDs 4, a motherboard 6 connecting the HDDs 4 and the control board 5, a control panel 7 to replace HDDs 4 and to manage the HDD array unit, two power supply units 8 to supply power to each of these units, and two fans 9 to cool the HDDs 4, control board 5, and similar.

Of the 15 HDDs 4, the ten HDDs 4(1) to 4(10) are HDDs for data, four HDDs 4(11) to 4(14) are HDDs for error correction, and the remaining one HDD 4(15) is a spare HDD.

In the case where one among the HDDs 4(1) to 4(14) malfunctions, and the data of this HDD is restored and recorded (rebuilt) on the HDD 4(15), the malfunctioning HDD (HDD for data or for error correction) is moved to the position of the HDD 4(15). Further, in the case where the HDD is replaced, the spare HDD is moved to the position of this HDD. Hence in the initial state the HDDs 4(1) to 4(10), the HDDs 4(11) to 4(14), and the HDD 4(15) are respectively HDDs for data, HDDs for error correction, and the spare HDD; but each time rebuilding and replacement are performed, the positions of the data HDDs, error correction HDDs, and spare HDD change. However, as explained below, as the symbols representing the data HDDs, error correction HDDS, and spare HDD, the symbols HDD 4(1) to 4(10), HDDs 4(11) to 4(14), and HDD 4(15) are used throughout, respectively.

The control board 5 is connected to the input/output processor 1 by fiber channel 3, as also shown in FIG. 1, and is also connected to an external maintenance terminal (personal computer) 11 by Ethernet® 10.

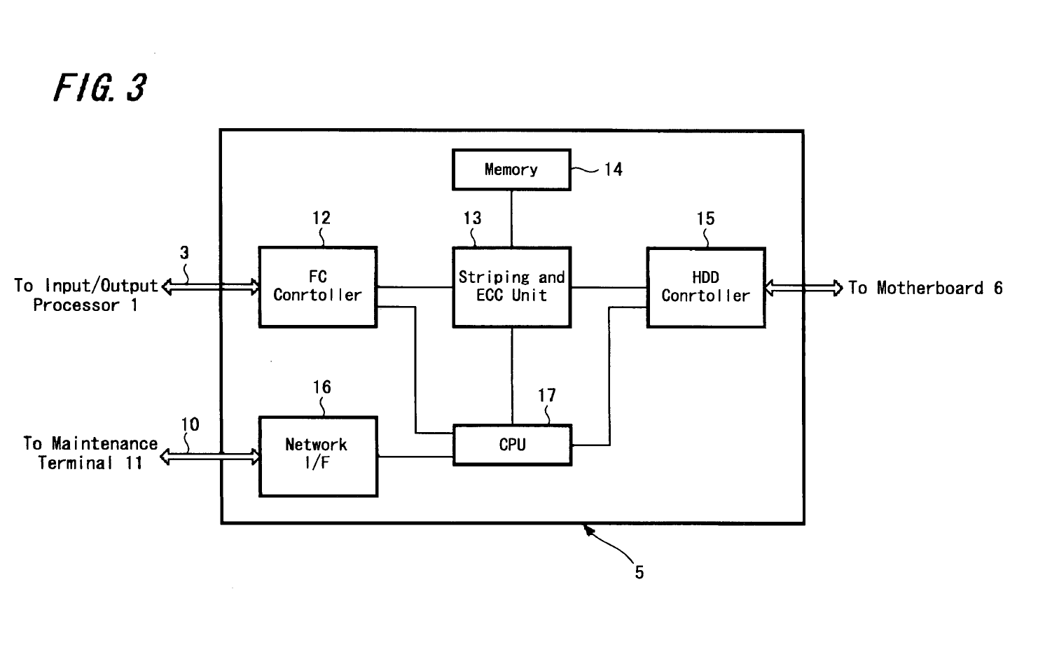

FIG. 3 is a block diagram showing the circuit configuration of the control board 5. The control board 5 includes a fiber channel controller 12, a striping and ECC unit 13, memory (RAM) 14, an HDD controller 15, a network interface 16, and a CPU 17. The striping and ECC unit 13 has an FPGA, which is a programmable LSI device.

Data transferred over the fiber channel 3 from the input/output processor 1 (FIG. 1) is sent to the striping and ECC unit 13 via the fiber channel controller 12. The striping and ECC unit 13 executes striping of the data thus sent into ten channels, to be recorded in the data HDDs 4(1) to 4(10) (FIG. 2) respectively, while buffering the data in memory 14. From the data in these ten channels, Reed-Solomon (14, 10) codes to be recorded in the four error correction HDDs 4(11) to 4(14) are generated.

The data to which striping is performed by the striping and ECC unit 13 is sent to the data HDDs 4(1) to 4(10) via the HDD controller 15 and motherboard 6 (FIG. 2), and is recorded in the HDDs 4(1) to 4(10).

The Reed-Solomon codes generated in the striping and ECC unit 13 are sent to the error correction HDDs 4(11) to 4(14) via the HDD controller 15 and motherboard 6, and are recorded in the HDDs 4(11) to 4(14). Hence this HDD array unit has redundancy equivalent to four HDDs.

During data reproduction, data read from each of the HDDs 4(1) to 4(10) and Reed-Solomon codes read from each of the error correction HDDs 4(11) to 4(14) are sent to memory 14 via the motherboard 6, HDD controller 15, and striping and ECC unit 13, and after buffering in memory 14, are sent to the striping and ECC unit 13. The striping and ECC unit 13 performs error correction, using the data from the HDDs 4(1) to 4(10) and the Reed-Solomon codes from the data from the error correction HDDs 4(11) to 4(14). Data reproduced in this way is transferred from the fiber channel controller 12 over the fiber channel 3 to the input/output processor 1.

Based on commands transferred together with the data from the input/output processor 1, the CPU 17 controls the HDDs 4(1) to 4(15). For example, if during data reproduction a malfunction or response delay occurs in any one of the data HDDs 4(1) to 4(10), the data in the HDD is restored, under the control of the CPU 17, using data read from the remaining data HDDs and Reed-Solomon codes read from the error correction HDDs 4(11) to 4(14).

As explained above, this HDD array unit has redundancy equivalent to the number of HDDs 4, so that even if malfunctions or response delays occurred in up to a maximum three units among the HDDs 4(1) to 4(14), data restoration could be performed while maintaining a redundancy of one or higher.

By this means, even if a malfunction or response delay occurred in one among the HDDs 4(1) to 4(14), operation of the AV server could be continued in a state in which redundancy was secured.

Further, data could be restored even without replacing malfunctioning HDDs, for up to a maximum of four malfunctioning HDDs 4(1) to 4(14). As a result, the number of maintenance sessions to replace malfunctioning HDDs can be reduced, so that maintenance costs can be alleviated.

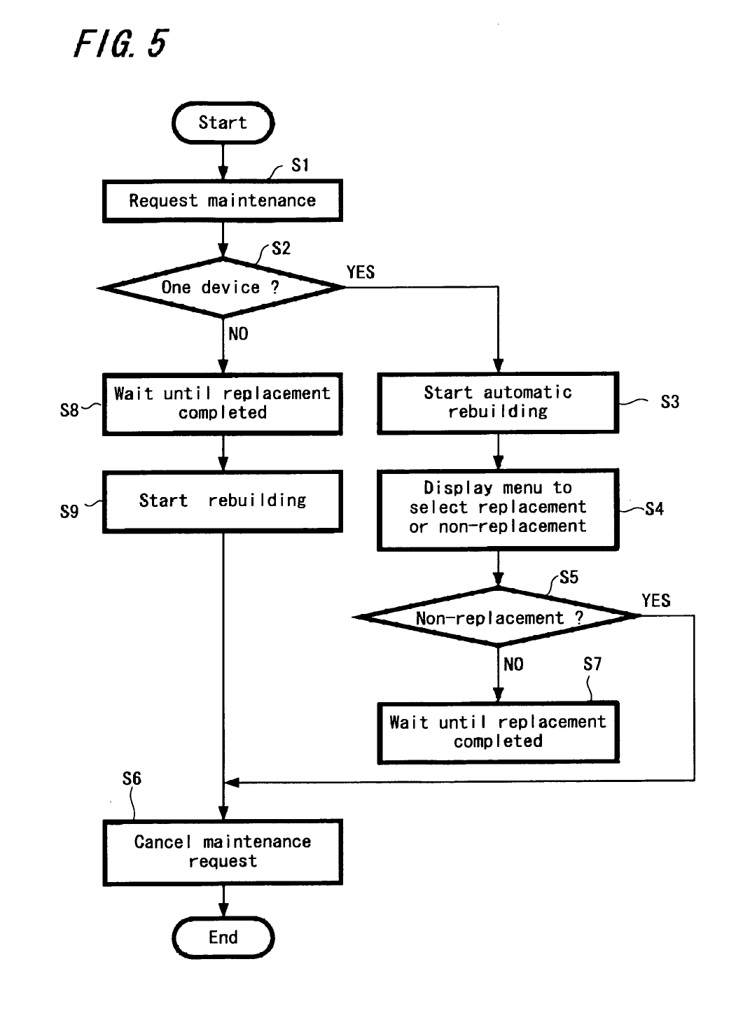

When one of the HDDs 4(1) to 4(14) has malfunctioned, the CPU 17 executes the processing shown in FIG. 5 explained below with respect to the malfunctioning HDD based on operation of the control panel 7 and maintenance terminal.

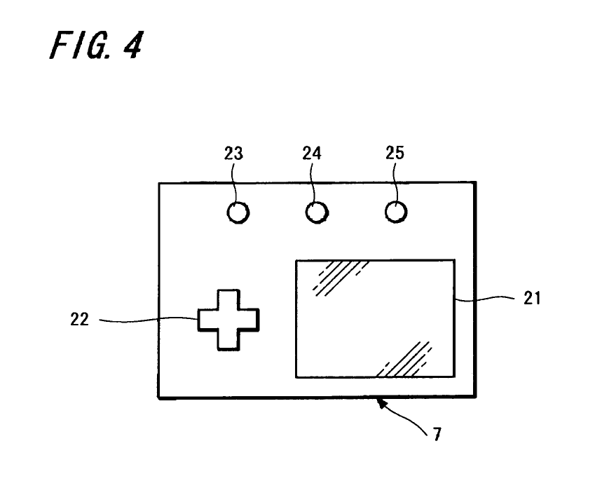

FIG. 4 shows an external view of the control panel 7 (FIG. 2). The control panel 7 is positioned on the surface of the housing of the storage unit, and is provided with an LCD (Liquid Crystal Display) to display various menus and states, a plus-shaped rocker key 22 to select from menus displayed on the LCD 21, and indicators which are LED (Light-Emitting Diode) lamps 23 to 25.

The LED lamp 23 is a system lamp, and is normally lit, but flashes orange during an HDD malfunction, and flashes red in the event of a serious fault such as renders data recording impossible. The LED lamp 24 is a power supply lamp, and is normally lit, but flashes orange when one among the two power supply units 8 (FIG. 2) malfunctions. The LED lamp 25 is a display lamp indicating the state of HDD access, and flashes during access.

The menus displayed on the LCD 21 include a menu to select whether or not to replace those HDDs among the HDDs 4(1) to 4(14) which have malfunctioned. Although not shown, the same menu is also displayed on the display of the above-described maintenance terminal 11 (FIG. 2).

FIG. 5 is a flow chart showing processing executed by the CPU 17 (FIG. 3) on the control board 5, with respect to replacement of malfunctioning HDDs, when any of the HDDs 4(1) to 4(14) malfunctions. This processing is initiated each time any of the HDDs 4(1) to 4(14) malfunctions; first, status information indicating the malfunction is output to the input/output processor 1 (FIG. 1), and a maintenance request (information requesting replacement of the malfunctioning HDD) is output to both the control panel 7 and to the maintenance terminal 11 (FIG. 2) (step S1).

At the control panel 7, the LED lamp 23 (FIG. 4) flashes orange in response to this maintenance request. At the maintenance terminal 11 also, although not shown, a predetermined warning is displayed on the display in response to the maintenance request.

Following step S1, a judgment is made as to whether this malfunction is the first malfunction (step S2). If “YES”, automatic rebuilding is begun using the spare HDD 4(15). That is, the data in the malfunctioning HDD among the HDDs 4(1) to 4(14) is restored from data read from the remaining HDDs 4(1) to 4(14) using Reed-Solomon codes, and the restored data is recorded in the spare HDD 4(15) (step S3).

Next, as explained above, a menu used to select whether or not to replace the malfunctioning HDD is displayed on the LCD 21 of the control panel 7 (FIG. 4) and on the display of the maintenance terminal 11 (step S4). A judgment is then made as to whether an operation has been performed at the control panel 7 or at the maintenance terminal 11 to select not to perform replacement (step S5).

If “YES”, information canceling the maintenance request output in step S1 is output to both the control panel 7 and to the maintenance terminal 11 (step S6). Processing then ends.

At the control panel 7, the LED lamp 23 returns to the normal lit state in response to this cancellation information. At the maintenance terminal 11 also, the above-described warning display is cancelled in response to this maintenance request cancellation.

When in step S5 the response is “NO” (when an operation has been performed selecting the replacement of the malfunctioning HDD), standby is entered until the malfunctioning HDD replacement is completed (step S7). Upon completion of replacement, processing advances to step S6.

When in step S2 the response is “NO” (when the malfunction is in two or more HDDs), similarly to step S7, standby is entered until the completion of replacement of the malfunctioning HDDs (step S8).

When replacement is completed, rebuilding is begun. That is, if there are malfunctions in two HDDs, for example, the data in the malfunctioning HDDs is restored from data read from the thirteen HDDs excluding the two malfunctioning HDDs among the HDDs 4(1) to 4(15), using Reed-Solomon codes, and the restored data is recorded in the newly replaced data HDDs (step S9). Processing then proceeds to step S6.

Next, the manner in which redundancy is secured when malfunctions occur in HDDs 4(1) to 4(14) in the HDD array unit, and the manner in which the number of maintenance sessions to replace malfunctioning HDDs is reduced, are explained. When a malfunction occurs in one HDD in the HDD array unit, after a maintenance request is output, the data is recovered (rebuilt) automatically on the spare HDD 4(15) (steps S1 to S3 in FIG. 5).

As described above, in the HDD array unit in the past having a RAID level 3 or level 5 configuration, during rebuilding the system reliability is greatly reduced due to loss of HDD redundancy. On the other hand, in the HDD array unit of this embodiment, the reliability of the system (AV server) is retained by securing a minimum HDD redundancy of three. In addition, even if one HDD were to malfunction there would be no need to immediately replace the HDD, and so the user could cancel the maintenance request by operating the control panel 7 or maintenance terminal 11 (so that maintenance would not be performed) (steps S4 to S6 in FIG. 5).

However, when a single HDD is malfunctioning, if other maintenance happens to be in progress (if a service technician is present), then if the service technician replaces the malfunctioning HDD, the maintenance request is automatically cancelled, and all HDDs return to the normal state (steps S5, S6, S7 in FIG. 5).

If thereafter two HDDs malfunction, because the spare HDD is already in use, rebuilding is not started automatically. In this case also, the data in the HDD which was the first to malfunction is automatically rebuilt and recorded to the spare HDD, so that a redundancy of three is secured.

The control panel 7 and maintenance terminal 11 are designed such that when a second HDD malfunctions, the maintenance request cannot be cancelled, and so maintenance by a service technician is requested, and upon replacing the HDDs, the data is recovered (rebuilt) to the newly replaced HDDs, after which the maintenance request is automatically cancelled (steps S1, S2, S8, S9, S6 in FIG. 5). At the time of the malfunction in the second HDD, by replacing all at once both the HDDs which have malfunctioned up to that time, the number of maintenance sessions is reduced by half from the case of performing replacement each time an HDD malfunctions.

Moreover, even when there is a malfunction in only one HDD, if there happens to be maintenance in progress (a service technician is on site), by replacing the HDD (steps S5, S7, S6 in FIG. 5), the total number of maintenance sessions can be further reduced.

Almost all of the HDDs currently in use have a MTBF (Mean Time Between Failures) of 800,000 hours or more, whereas the warranty period (period of use) for an HDD array unit is, for example, five years or less. In the case where an AV server is used continuously, 24 hours a day and 365 days a year, the predicted failure rate for HDDs in a five-year period, calculated from the MTBF, is approximately 5.3%; when 14 HDDs are used per HDD array unit, it is predicted that approximately one HDD will fail in a five-year period. Hence by performing the processing shown in FIG. 5, it is possible to achieve effectively maintenance-free operation.

Note that, in the above example, it is possible to operate the control panel 7 or maintenance terminal 11 to cancel a maintenance request, and not replace a malfunctioning HDD, only when a malfunction occurs in the first HDD (the same number of HDDs as there are spare HDDs). However, as another example, the system may be designed such that maintenance requests can be cancelled up until the number of malfunctioning HDDs reaches three units (at which time the redundancy is two), four units (at which time the redundancy is one), or five units (at which time there is no redundancy). In these cases, it is possible to reduce the number of maintenance sessions to ⅓, ¼, and ⅕ the normal number, respectively.

Further, in the above embodiment, a single spare HDD is provided; but as another example, the number of spare HDDs may be two units (with nine data HDDs and four error correction HDDs), or the number of spare HDDs may be three units (with eight data HDDs and four error correction HDDs). By thus increasing the number of spare HDDs, automatic rebuilding can be performed when two or three HDDs have malfunctioned, similarly to the case of a single malfunctioning HDD, so that the number of maintenance sessions can be further reduced. However, because the HDD configuration is frequently subject to constraints imposed by the required recording capacity (the number of data HDDs) and costs, in actual practice the number of spare HDDs will often be one.

Further, in the above example fifteen HDDs are mounted; but a greater number of HDDs than fifteen may be mounted, in order to further increase the HDD redundancy or increase the number of spare HDDs to two or greater.

Furthermore, in the above example, ten data HDDs and four error correction HDDs are provided; but the number of data HDDs and error correction HDDs may each be set to appropriate plural values.

Moreover, in the above example, the present invention is applied to an HDD array unit used as an AV server; but this invention may be applied to other HDD array units as well. Further, this invention may also be applied to systems other than HDD array units which are data storage apparatuses, and in which are mounted a plurality of recording media (for example, semiconductor memory devices or optical discs) within a single unit.

It should be understood by those skilled in the art that various modifications, combinations, sub-combinations and alterations may occur depending on design requirements and other factors, insofar as they are within the scope of the appended claims or the equivalents thereof.

What is claimed is:

1. A data storage apparatus, comprising:
a plurality of data recording means;
a plurality of error correction recording means;
data distribution and error correction code generation means, which distribute and record input data in said data recording means, generate error correction codes from said data in accordance with the number of said error correction recording means, and record said error correction codes in said error correction recording means; and
data restoration means, which restore the data in recording means in which a malfunction or response delay has occurred, among said data recording means and error correction recording means, using data and error correction codes read from remaining recording means.

2. The data storage apparatus according to claim 1, further comprising:
request output means which output information to request replacement of malfunctioning recording means and
operation means to select whether or not to replace malfunctioning recording means, until the number of malfunctioning recording means is equal to the maximum number of said error correction recording means,
wherein, in the case where said operation means selects replacement not to be performed, said request output means halt output of said information even when malfunctioning recording means are not replaced.

3. The data storage apparatus according to claim 2,
wherein said operation means is a control panel of said data storage apparatus or an external terminal.

4. The data storage apparatus according to claim 3,
wherein said control panel comprises:
a display device to display a menu for selecting whether or not to replace said malfunctioning recording means;
a system lamp to display the malfunction state of said recording means;
a power supply lamp; and
a display lamp to display the access state of said recording means.

5. The data storage apparatus according to claim 1, further comprising:
at least one spare recording means, request output means which output information to request replacement of malfunctioning recording means, and
operation means to select whether or not to replace malfunctioning recording means, until the number of malfunctioning recording means is equal to at least the number of said spare recording means,
wherein, in the case where recording means malfunction in a number within the range of the number of said spare recording means, said data restoration means record the restored data in said spare recording means, and
in the case where said operation means select replacement not to be performed, said request output means halt output of said information even when malfunctioning recording means are not replaced.

6. The data storage apparatus according to claim 5,
wherein said operation means is a control panel of said data storage apparatus or an external terminal.

7. The data storage apparatus according to claim 6,
wherein said control panel comprises:
a display device to display a menu for selecting whether or not to replace said malfunctioning recording means;
a system lamp to display the malfunction state of said recording means;
a power supply lamp; and
a display lamp to display the access state of said recording means.

8. A data storage method, in a data storage apparatus including a plurality of data recording means and a plurality of error correction recording means, comprising:
a data distribution and recording step of distributing and recording input data to said data recording means;
an error correction code generation and recording step of generating error correction codes from said data in accordance with the number of said error correction recording means and of recording said error correction codes in said error correction recording means; and
a data restoration step of restoring data in recording means in which a malfunction or response delay has occurred among said data recording means and said error correction recording means, using data and error correction codes read from remaining recording means.

9. The data storage method of a data storage apparatus according to claim 8, further comprising:
an request output step of outputting information to request replacement of malfunctioning recording means and
an operation step of selecting whether or not to replace malfunctioning recording means, until the number of malfunctioning recording means is equal to the maximum number of said error correction recording means,
wherein, in the case where in said operation step replacement is not selected to be performed, said request output step halt output of said information even when malfunctioning recording means are not replaced.

10. The data storage method of a data storage apparatus according to claim 9,
wherein said operation step is an operation performed at a control panel of said storage apparatus or at an external terminal.

11. The data storage method of a data storage apparatus according to claim 10,
wherein said control panel operation is operation of a menu on a display device on the control panel to select whether or not to replace said malfunctioning recording means.

12. The data storage method of a data storage apparatus according to claim 8, in which said storage apparatus further includes at least one spare recording means, further comprising:
a request output step of outputting information to request replacement of malfunctioning recording means, and
an operation step of selecting whether or not to replace malfunctioning recording means, until the number of malfunctioning recording means is at least equal to the number of said spare recording means;
wherein in the case where recording means malfunction in a number within the range of the number of said spare recording means, in said data restoration step the restored data is recorded to said spare recording means; and
in the case where in said operation step replacement is not selected to be performed, said request output step halt output of said information even when malfunctioning recording means are not replaced.

13. The data storage method of a data storage apparatus according to claim 12,
wherein said operation step is an operation performed at a control panel of said storage apparatus or at an external terminal.

14. The data storage method of a data storage apparatus according to claim 13,
wherein said control panel operation is operation of a menu on a display device on the control panel to select whether or not to replace said malfunctioning recording means.

15. A data storage method, in a data storage apparatus including a plurality of data recording devices, a plurality of error correction recording devices, and at least one spare recording device, comprising:
a data restoration step of restoring data in recording devices in which a malfunction or response delay has occurred among said data recording devices and said error correction recording devices, using data and error correction codes read from remaining recording devices;
a request output step of outputting information to request replacement of malfunctioning recording devices; and
an operation step of selecting whether or not to replace malfunctioning recording devices, until the number of malfunctioning recording devices is at least equal to the number of said spare recording devices;
wherein in the case where recording devices malfunction in a number within the range of the number of said spare recording devices, in said data restoration step the restored data is recorded to said spare recording devices; and
in the case where in said operation step replacement is not selected to be performed, said request output step halts output of said information even when malfunctioning recording devices are not replaced.

16. The data storage method of a data storage apparatus according to claim 15,
wherein in the case where recording devices malfunction in a number outside the range of the number of said spare recording devices,
after replacement of said malfunctioning recording devices, in said data restoration step the restored data is recorded to replaced recording devices; and,
in said request output step, output of said information is halted after data restoration.

17. The data storage method of a data storage apparatus according to claim 15,
wherein said operation step is an operation performed at a control panel of said storage apparatus or at an external terminal.

18. The data storage method of a data storage apparatus according to claim 17,
wherein said control panel operation is operation of a menu on a display device on the control panel to select whether or not to replace said malfunctioning recording devices.

19. A data storage apparatus, comprising:
a plurality of data recording units;
a plurality of error correction recording units;
a data distribution and error correction code generation unit, which distributes and records input data in said data recording units, generates error correction codes from said data in accordance with the number of said error correction recording units, and records said error correction codes in said error correction recording units; and
a data restoration unit, which restores the data in said recording unit in which a malfunction or response delay has occurred, among said data recording units and error correction recording units, using data and error correction codes read from remaining recording units.
